(19) United States
(12) Patent Application Publication
(10) Pub. No.: US 2014/0378144 A1
(43) Pub. Date: Dec. 25, 2014

(54) HANDOVER METHOD IN A CELLULAR WIRELESS COMMUNICATION SYSTEM

(71) Applicant: HUAWEI TECHNOLOGIES CO., LTD., Shenzhen (CN)

(72) Inventors: Peter LEGG, Kista (SE); Hui Gao, Shanghai (CN); Guohua Zhou, Shanghai (CN)

(73) Assignee: HUAWEI TECHNOLOGIES CO., LTD., Shenzhen (CN)

(21) Appl. No.: 14/478,357

(22) Filed: Sep. 5, 2014

Related U.S. Application Data
(63) Continuation of application No. PCT/EP2012/053751, filed on Mar. 5, 2012.

(51) Int. Cl. H04W 36/30; H04W 24/10

(52) U.S. Cl. CPC H04W 36/30; H04W 24/10
USPC 455/437

(57) ABSTRACT

Embodiments of the present invention relate to a method for handover in a cellular wireless communication system, the method comprising: monitoring a downlink SINR value SINR_{DL} between a source cell for a mobile station and the mobile station; selecting a target cell based on one or more measurement reports from the mobile station, wherein the measurement reports include measurements on reference signals transmitted from one or more candidate target cells; initiating a handover preparation to the selected target cell for the mobile station based on the downlink SINR value SINR_{DL}; and handing over the mobile station from the source cell to the selected target cell. Furthermore, the invention also relates to a method in a network control node, a network control node device, a computer program, and a computer program product thereof.

### CROSS-REFERENCE TO RELATED APPLICATIONS

This application is a continuation of International Application No. PCT/EP2012/053751, filed on Mar. 5, 2012, which is hereby incorporated by reference in its entirety.

### TECHNICAL FIELD

Embodiments of the present invention relate to a handover method in a cellular wireless communication system. Furthermore, embodiments of the invention also relate to a method in a network control node, a network control node device, a computer program, and a computer program product thereof.

### BACKGROUND

Normally a user equipment (UE) in active mode in a cellular wireless communication system is handed over from one cell to the next as it moves through the network, and data can be transmitted and received without significant interruptions due to these handovers.

The handover (HO) procedure can consist of many steps. In most cellular wireless communication systems the handover is:
1) network controlled, i.e. the UE is commanded by the network when to connect to another cell;
2) prepared, i.e. the target cell (the cell that UE is moving to) is prepared;
3) UE assisted, i.e. the UE provides measurement reports before handover, to the serving cell to assist the decision to do handover preparation of target cell(s), and when to leave the serving cell/connect to the target cell.

In the context of handover, the serving cell before handover is often referred to as the source cell. After successful handover the target cell becomes the new serving cell. In LTE, the handover is a so called “hard handover”, i.e. the UE radio link is switched from one cell (source) to another (target). In universal mobile telecommunications system (UMTS) hard handovers are used exclusively for time division duplexing (TDD) mode and may be used for frequency division duplexing (FDD) mode too.

In the following discussion, see FIG. 1, the focus is on the intra frequency long term evolution (LTE) handover procedure, but the procedures are similar for the LTE inter radio access technology (RAT) and LTE inter frequency handover procedures. The intra evolved universal terrestrial radio access network (E-UTRAN) in RRC_CONNECTED state is UE assisted network controlled handover, with handover preparation signalling in E-UTRAN. The figure below depicts the basic handover scenario where core network nodes (the mobility management entity (MME) and serving gateway (S-GW)) do not change.

The handover is initially triggered by a measurement report sent from the UE to the serving eNB. The serving evolved Node B (eNB) configures how the UE shall take measurements (“Measurement Control” step 1 in FIG. 1) and under what conditions a measurement report shall be triggered and sent to the eNB.

To assist mobility control decisions, the UE can measure several different candidate targets cells and report the results to the network. In LTE, for intra-frequency handovers, the UE detects and takes measurements on neighbouring cells automatically (there is no need for the network to identify which cells should be measured, although black lists (cells that should not be measured) and white lists (cells that shall be measured) may be used by the network is desired). Different networks and network deployments can have different detailed behaviour, but in most networks it is natural to trigger handover when signal reception from a target cell is better than from the source cell (FIG. 2). In the measurement report the UE includes the reason for the trigger (e.g. target cell stronger than serving cell) and measurements of the reference signal strength (RSRP) or quality (RSRQ) of the serving cell and several neighbours (including the target cell). To reduce ping-pong effects where a UE hands over repeatedly between two cells a handover offset value is often added to the trigger condition: target cell should be better than the serving cell by the handover offset value (offset >0 dB).

When the serving eNB receives a measurement report and if it desires to handover the UE to another cell it performs a handover preparation to that cell. Handover preparation involves a signalling exchange between one eNB and another eNB. The source cell requests the handover (Handover Request, step 4) and passes over UE context information; the target cell decides if it can admit the UE (Call Admission Control, step 5) and either accepts or rejects the handover. In the acceptance message (Handover Request Ack., Step 6) the target cell includes parameters required by the UE to allow it to communicate to the target cell—these parameters are grouped into a transparent container.

Following a successful preparation, the handover execution takes place. The source cell issues the HO Command to the UE—this is the RRCConnectionReconfiguration message and carries the transparent container. If and when the UE receives this correctly it synchronises to the new target cell and sends a synchronisation message on the random access channel (RACH, step 9). The target cell then issues an allocation to the UE (step 10) so that it can send a HO Confirmation message to the target cell (the RRCConnectionReconfigurationComplete message, step 11).

The final steps, the Handover Completion, do not involve the UE. The source eNB is able to forward data (unacknowledged downlink packets) to the target eNB, and the S1-U interface from the S-GW must be switched from the source to the target (“path switch”). Finally, if the handover is successful the target eNB issues a UE Context Release message to the source eNB.

A successful handover requires (see FIG. 1):
Measurement report delivery from the UE to the serving cell, followed by handover decision at the serving cell;
Communication over the X2 between the serving and target eNB (HO preparation);
Delivery of the HO Command RRC message from the serving cell to the UE;
Successful random access and delivery of a HO Confirm RRC message to the target cell.

Failure of a handover can occur at any of these stages. The transmission of the RRC signalling to/from the UE is managed by the RLC AM protocol and this judges when failure has occurred (and attempts to transmit the message should be ceased). Additionally, the UE performs measurements of the quality of the downlink of the serving cell and can determine a radio link failure at the physical layer level when the quality is judged to be poor for a duration equal to a timer value, “T310”. Since the “offset” is typically assumed to be greater than zero (otherwise ping-pong handovers between source and target are very likely), the majority of failures are expected to occur in the source cell before the HO Command has been delivered—the HO begins when the UE is already closer (in radio terms) to the target cell than to the source, and the UE moves further from the source as the handover proceeds. This generalization may be broken by randomness in the UE motion and by fragmented coverage caused by shadowing.

The UMTS hard handover is very similar in many respects it exploits preparation (using RL Setup procedure), is a “backward” handover (the source cell sends the HO command to the UE and the UE replies to the target cell) and is completed by inter-node signalling.

Handover algorithms are concerned with two performance aspects above, namely:
Failures during the handover, or before the handover has been triggered; and
Number of handover events, however less important than the case above.

Regular A3 Handover

A common approach to LTE handover is to configure a so called Event A3 with an entry condition that a neighbour cell is “offset” dB better than the serving cell. The measurements are filtered by the UE at L1 and optionally at L3 using a single tap IIR filter with coefficient specified by parameter “K”. When the eNB receives a triggered measurement report it initiates the handover immediately. In most circumstances this method works well. However, the weaknesses with this method are:
Handover is triggered by RSRP difference between serving cell and one target cell (the strongest), but in many cases other cells can be present and cause significant interference to the HO Command transmission. In other words the RSRP difference does not always reflect the signal to interference plus noise ratio (SINR) for the HO Command;
Triggering is also possible using RSRQ but this has been shown to be a poor representation of SINR unless cells are fully loaded;
Handovers can be triggered when the link quality in the serving cell is actually satisfactory;
Handover timing may be tuned for different UEs by configuring different offset values. This may be desirable because different UEs may have different speeds or different quality requirements for their traffic bearers. Faster UEs suffer more handover failures which can be addressed by timing the handover earlier (e.g. using a smaller offset). However, individual settings require direct RRC signalling to the UE which can be an overhead on the air interface (especially if frequent changes are made as, for example, speed changes);
A similar issue is that handover failure rates can differ according to different radio conditions at different points on the cell border between two cells. In black spot areas the shadowing is greater and this leads to higher failures rates. If the location of the UE is unknown (typically the case) the network does not know in advance if a UE is crossing the border in a black spot or not. The optimum handover settings differ accordingly (to achieve the same failure rate we need, for example, a smaller offset when crossing in a black spot so that the handover is executed earlier). Some compromise must be made—tuning the offset to give a low value to give a low failure rate measured over all handovers across the border will result in many handovers and handover ping-pongs. This is because the offset is then sub-optimal for handovers away from the black spot.

According to another prior art handover solution, the configuration of transmissions of sounding Reference Symbols (RS) by the UE is used to get the uplink quality in serving and target cells. Handoff resolution relies on both a downlink channel quality indication between a serving base station and the mobile terminal, and uplink channel quality indications amongst the terminal and a measurement set of target base stations. To generate UL channel quality indicators, the mobile station conveys a narrowband or broadband sounding reference signal, and serving and target base stations measure UL and DL performance metrics (e.g., RSRP, RSSI, or RSOT). In backward handover, UL channel state information from target cells is received at the serving base station through backhaul communication, and handoff is resolved based on both UL and DL quality reports. DL channel quality is estimated based upon wideband or narrowband CQI. A disadvantage with this method is that the method exploits uplink quality measurements (in the target cell) which must be extracted and sent to the source cell. Such measurements have little relevance to the handover success because for intra-frequency handovers the handover command is critical, and for inter-frequency or inter-RAT handovers the uplink quality in the source cell is also important.

According to yet another prior art handover solution the handover method compares the downlink quality of serving and target cells. This is similar to an A3 event using RSRQ measurements, but suffers from drawbacks mentioned above since RSRQ it not a good measure of quality.

### SUMMARY

An aspect of the present invention is to provide a solution which mitigates or solves the drawbacks and problems of prior art solutions.

Another aspect is to provide a handover method having better handover performance than prior art handover methods.

According to a first aspect of the invention, the above mentioned aspects are achieved by a method for handover in a cellular wireless communication system, said method comprising the steps of:
monitoring a downlink SINR value SINR_{DL} between a source cell for a mobile station and said mobile station;
selecting a target cell based on one or more measurement reports from said mobile station, wherein said measurement reports include measurements on reference signals transmitted from one or more candidate target cells;
initiating a handover preparation to said selected target cell for said mobile station based on said downlink SINR value SINR_{DL}; and
handing over said mobile station from said source cell to said selected target cell.

Different embodiments of the handover method are disclosed in the appended claims.

According to a second aspect of the invention, the above mentioned aspects are achieved by a

method in a network control node arranged for communicating in a wireless communication system, said method comprising the steps of:
monitoring a downlink SINR value SINR_{DL} between said network control node and a mobile station;
selecting a target cell for said mobile station based on one or more measurement reports from said mobile station, wherein said measurement reports include measurements on reference signals transmitted from one or more candidate target cells;
initiating a handover preparation to said selected target cell for said mobile station based on said downlink SINR value SINR_{DL}; and
transmitting a handover command message to said mobile station.

The invention also relates to a computer program and a computer program product.

According to a third aspect of the invention, the above mentioned aspects are achieved with a network control node device arranged for communicating in a wireless communication system, the network control node device further being arranged to:
monitor a downlink SINR value SINR_{DL} between said network control node device and a mobile station;
select a target cell for said mobile station based on one or more measurement reports from said mobile station, wherein said measurement reports include measurements on reference signals transmitted from one or more candidate target cells;
initiate a handover preparation to said selected target cell for said mobile station based on said downlink SINR value SINR_{DL}; and
transmit a handover command message to said mobile station.

The present invention provides a handover method which inherently adapts to different radio conditions for individual handover events such as shadow fading, mobile station speed, and cell load. Further, the invention also addresses a main factor for handover success, i.e. downlink SINR in the source cell for the mobile station. Also, handover timing is automatically adjusted across a complete cell border, which means no compromise to fix handovers in particular black spots. As a result the present invention provides a handover method which compared to the prior art methods either results in fewer handover events and the same handover failure rate, or equal number of handover events and a smaller handover failure rate.

Further applications and advantages of the invention will be apparent from the following detailed description.

### BRIEF DESCRIPTION OF DRAWINGS

The appended drawings are intended to clarify and explain different embodiments of the present invention in which:

FIG. 1 illustrates LTE intra-frequency handover;

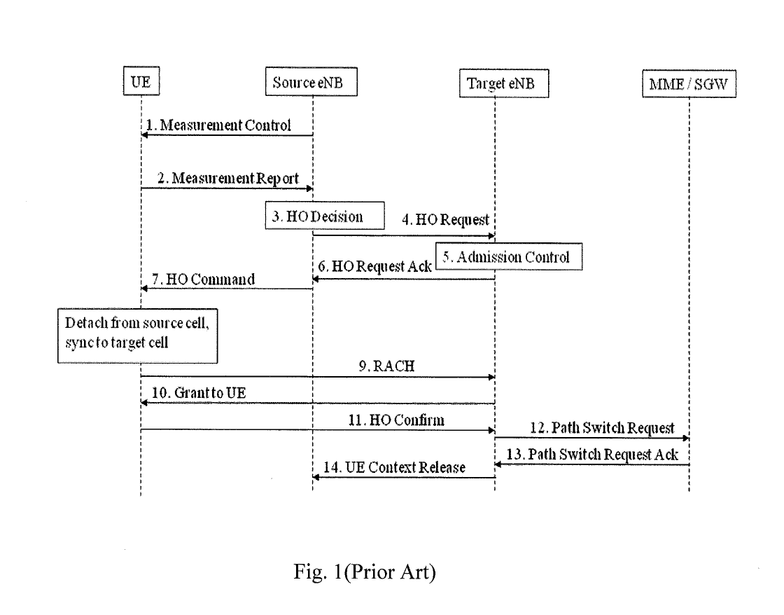

FIG. 2 illustrates a handover cell scenario;

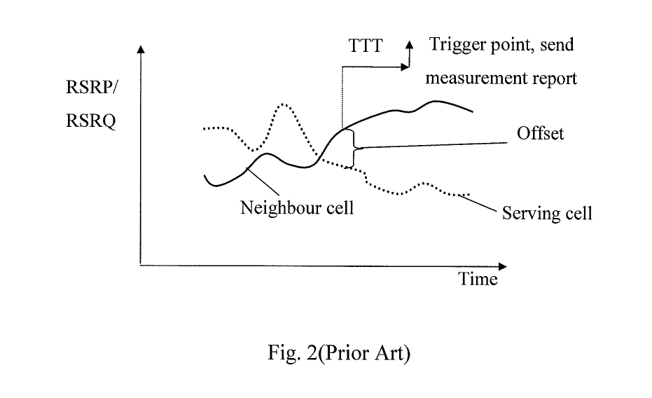

FIG. 3 illustrates an embodiment of the present invention; and

FIG. 4 illustrates an algorithm for tuning a handover parameter used in the present method.

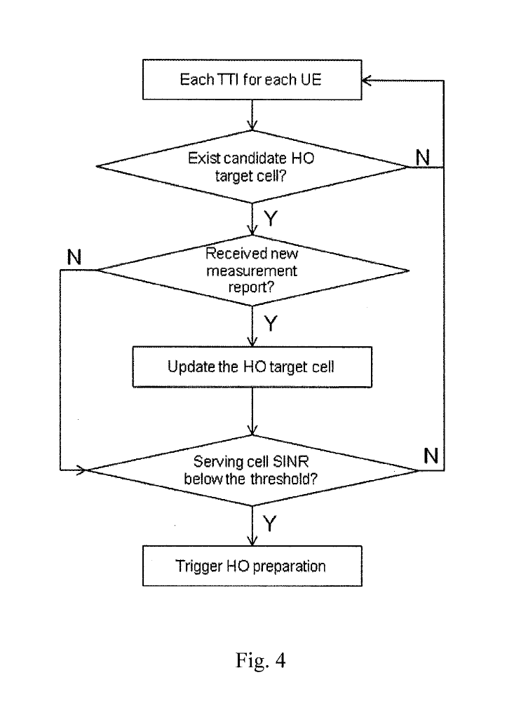

### DESCRIPTION OF EMBODIMENTS

To achieve the aforementioned and other aspects, the present invention relates to a handover method in a wireless communication system. The method comprises the steps of: monitoring a downlink SINR value SINR_{DL}, between a source cell for a mobile station and the mobile station; selecting a target cell based on one or more measurement reports from the mobile station, wherein the measurement reports include measurements on reference signals transmitted from one or more candidate target cells; initiating a handover preparation to the selected target cell for the mobile station based on the downlink SINR value SINR_{DL}; and finally, handing over the mobile station from the source cell to the selected target cell. Candidate target cells are the cells which the mobile station has detected.

The invention therefore separates the signalling that carries measurements to identify the best target cell (i.e. the selected target cell) from the signalling (downlink SINR value SINR_{DL}) that determines the time to execute the handover for a mobile station. This is beneficial because the measurement reports alone do not provide a good basis to judge when the handover should be executed. For example, if a difference in RSRP values between a source and target cells is used then this represents an SINR that ignores interference from other cells. If RSRQ values are used (e.g. RSRQ in the source cell) then this is an inaccurate representation of the SINR.

According to an embodiment of the invention, the handover preparation is initiated if the downlink SINR value SINR_{DL} is less than a SINR threshold value SINR_{TR}, i.e. if SINR_{DL}<SINR_{Tr}. The use of a threshold SINR value for initiating the handover preparation is advantageous because studies have shown that the delivery of the handover command is the key factor for handover success and this is dependent on the SINR threshold value SINR_{Tr}.

Regarding the downlink SINR value SINR_{DL} these can be estimated in a number of different ways as realized by the skilled person. The downlink SINR value SINR_{DL} is preferably estimated by using one or more channel measurements in the group comprising: CQI reports, RSRP reported measurements, and RSRQ reported measurements. CQI reports are readily obtainable from the UE using standardized procedures (periodic or aperiodic reporting), whilst RSRP/RSRQ measurements may be sent to the network node that controls the handover in measurement reports.

If RSRP reported measurements are used for estimating the downlink SINR value SINR_{DL} and if the Physical Resource Block (PRB) usage is 100% in reported neighbour cells and there is no downlink power control (power spectral density equal for all PRBs) equation 1 below can be used. This method is only able to include (in the denominator) the interference from neighbour cells for which measurement reports have been received.

$${SINR}_{serving} = \frac{RSRP\_serving}{noise + \sum RSRP\_neighboring} \qquad ( 1 )$$

If the RSRQ measured in the serving cell is known the SINR may be determined by equation 2. This formula is accurate if all cells that cause downlink interference to the UE have a Physical Resource Block PRB usage of 100% and there is no downlink power control.

$${SINR}_{serving} = \frac{RSRQ\_serving}{\frac{1}{12} - RSRQ\_serving} \qquad ( 2 )$$

When the PRB load is not 100%, the above formulae may need be modified to reflect the reduced interference from the candidate cells. This makes the calculations more complex because different cells employ different frequency allocations for the reference symbols (according to their PCI, physical cell ID, etc).

It should be noted that further channel quality parameters can also be considered together with the downlink SINR for initiating the handover preparation. Therefore, the handover method can also comprise the step of monitoring an uplink SINR value SINR_{UL} between the source cell and the mobile station which means that the step of initiating the handover preparation further is based on an uplink SINR value SINR_{UL}. This is of particular importance for inter-frequency and inter-RAT handovers where the downlink signalling from the source cell can have very good SINR when the mobile moves to the edge of coverage of one RAT or frequency (so there is little interference from neighbour cells of the same RAT and frequency). Instead the uplink quality to the source cell can limit the handover performance, particularly because the coverage of an edge of coverage cell will be extended compared to cells surrounded by neighbours (of the same RAT and frequency), giving unusually high path loss for uplink transmissions by the mobile station.

As described above, the present method base the selection of the target cell among the candidate cells on measurements reports transmitted from the mobile station. The measurements reports include measurements on cell specific reference signals transmitted from the different candidate cells. The measurement reports preferably comprise RSRP and/or RSRQ measurements. These are standardized measurements in 3GPP specifications. As for the selection of the target cell, the cell which has the strongest signal strength among the candidate target cells in a last measurement report received from the mobile station is selected as the target cell.

In selecting the target cell on one or more further parameters can be used. The group of parameters comprises: load in the candidate target cells; cell size of the candidate target cells; transmission power of the candidate target cells; and handover history of the candidate target cells, such as handover failure rate. These additional parameters are useful when the criterion for selecting the target cell is more complex, considering more than just the strength of the target cell (RSRP). For example, the load may be useful if the source cell would like to ensure the handover preparation is successful—if the target is fully loaded the preparation may be rejected. The source cell can attempt to balance load between potential target cells. It may push UEs to cells that are loaded but not fully loaded to allow other cells to be switched off (e.g. to save network energy saving). The cell size is important in a heterogeneous deployment employing a mixture of large (macro) cells and small (micro/pico) cells. In this case the source cell can decide to avoid choosing a small target cell if the mobile station is known to be moving at a significant speed (e.g. in a vehicle). This would prevent a short stay time in the target cell. Handover history can be used to direct the mobile to a cell which has historically demonstrated a high handover success rate for incoming handovers from the source cell.

It has been realized that the measurements reports may be transmitted periodically or non-periodically from the mobile station. In both cases, the transmission of the measurements reports are triggered if a reference signal measurement of a candidate target cell is greater than a reference signal measurement of the source cell by at least a threshold handover offset value according to an embodiment of the invention. It has from tests been concluded that the handover offset value can be less than 2 dB, and preferably equal to or less than 1 dB which is lower than used in current systems. This relatively low offset value ensures that one or more measurement reports are delivered before the handover trigger time (as judged by the SINR), and thus the target cell identity is known. An even smaller offset will result in a greater number of measurement reports and thus unwanted signaling load within the network and battery consumption for the UE. Other ways of triggering the transmission of the measurements reports is by letting the transmission be triggered by A2, A3, A4, A5, B1, B2, 3A, 3C, 3D, 2B, 2C, 1C, 1E or 1G events if the wireless communication system is a 3GPP system such as LTE or UMTS.

According to yet another embodiment of the invention the present handover method further involves receiving the measurement reports from the mobile station to be handed over so as to trigger the monitoring of the SINR by the reception of the first measurement report. Thereby the monitoring can be avoided until a possible target cell has been identified by the reception of the first measurement report. In another embodiment, the reception of the first or subsequent measurement report can be used to increase the frequency of CQI reporting by the mobile station. The period of periodic CQI reports can be reduced or more frequent aperiodic reports can be requested.

In a further embodiment of the invention, the SINR may be estimated from measurements made by the mobile station on reference symbols or pilot sequences dedicated to the mobile station itself, and then signalled to the base station or network controller. In another similar embodiment measurements made on transmissions carrying payload data may be used for estimation of the SINR.

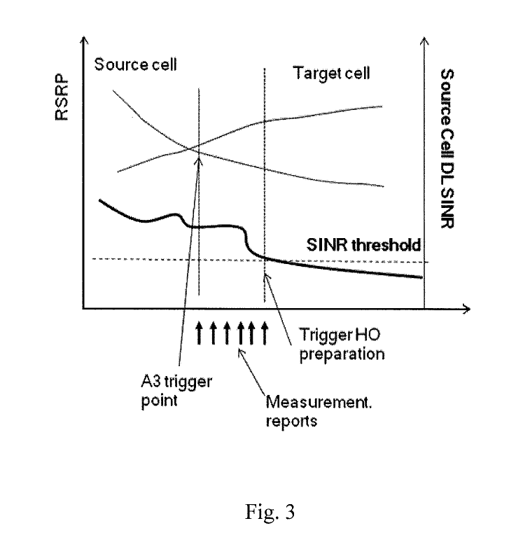

To provide a deeper understanding of the present invention the handover method may work as described in the following and which is also illustrated in FIG. 3:
(1) The source cell configures a “triggered periodic” A3 event with a low offset (e.g. 1 dB) and 0 ms Time to Trigger (TTT),
   The UE will generate a measurement report when a target cell RSRP is “offset” dB better than the serving cell RSRP, which is the A3 trigger point in FIG. 3,
   The UE will continue to generate measurement reports periodically whilst this condition is true;
(2) Once a report has been received, the source cell monitors downlink SINR in source cell (if it is not already doing so),
   The downlink SINR is estimated by using one or more of CQI reports, RSRP reported measurements, and RSRQ reported measurements;
(3) Once the downlink SINR passes below a threshold value, the handover preparation is triggered for the strongest target cell among the candidate cells in the last measurement report.

Moreover, the invention also relates to a method in a network control node and to a corresponding network control node device. The method comprises the steps of: monitoring a downlink SINR value SINR_{DL} between the network control node and a mobile station; selecting a target cell for the mobile station based on one or more measurement reports from the mobile station, wherein the measurement reports include measurements on reference signals transmitted from one or more candidate target cells; initiating a handover preparation to the selected target cell for the mobile station based on the downlink SINR value SINR_{DL}; and transmitting a handover command message to the mobile station. The handover command instructs the UE to undertake the handover and connect to the specified target cell. The network control node can be any suitably arranged control node such as a base station, an eNode B, a Base Station Controller (BSC) or a Radio Network Controller (RNC).

Furthermore, as understood by the person skilled in the art, any method according to the present invention may also be implemented in a computer program, having code means, which when run by processing means causes the processing means to execute the steps of the method. The computer program is included in a computer readable medium of a computer program product. The computer readable medium may include essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Finally, it should be understood that the present invention is not limited to the embodiments described above, but also relates to and incorporates all embodiments within the scope of the appended independent claims.

What is claimed is:

1. A method for handover in a cellular wireless communication system, said method comprising:
monitoring a downlink SINR value between a source cell for a mobile station and said mobile station;
selecting a target cell based on at least one measurement reports from said mobile station, wherein said measurement reports include measurements on reference signals transmitted from one or more candidate target cells;
initiating a handover preparation to said selected target cell for said mobile station based on said downlink SINR value; and
handing over said mobile station from said source cell to said selected target cell.

2. The method according to claim 1, wherein said handover preparation is initiated if said downlink SINR value is less than a SINR threshold value.

3. The method according to claim 1, wherein said method further comprises:
estimating said downlink SINR value SINR_{DL} by using at least one of CQI reports, RSRP reported measurements, and RSRQ reported measurements.

4. The method according to claim 1, wherein said measurement reports are periodically or non-periodically transmitted by said mobile station, and said periodically or non-periodically transmitted measurement reports are triggered if a reference signal measurement of a candidate target cell is greater than a reference signal measurement of said source cell by at least a threshold handover offset value.

5. The method according to claim 1, wherein said cellular wireless communication system is a 3GPP wireless communication system; wherein said measurement reports are periodically or non-periodically transmitted by said mobile station, and said periodically or non-periodically transmitted measurement reports are triggered by any one of A2, A3, A4, A5, B1, B2, 3A, 3C, 3D, 2B, 2C, 1C, 1E and 1G event.

6. The method according to claim 1, wherein said selected target cell is a cell which has the strongest signal strength among said candidate target cells in a last measurement report received from said mobile station.

7. The method according to claim 1, wherein said method further comprises:
receiving said measurement reports; and said monitoring is triggered by the reception of a first measurement report.

8. The method according to claim 1, wherein said method further comprises:
monitoring an uplink SINR value between said source cell and said mobile station; and said initiating said handover preparation further is based on said uplink SINR value.

9. The method according to claim 1, wherein said selection of said target cell further is based on at least one of load in said candidate target cells, cell size of said candidate target cells, transmission power of said candidate target cells and handover history of said candidate target cells.

10. A computer-readable medium, for handover in a cellular wireless communication system, which, when executed by a computer unit, will cause the computer unit to:
monitor a downlink SINR value between a source cell for a mobile station and said mobile station;
select a target cell based on at least one measurement reports from said mobile station, wherein said measurement reports include measurements on reference signals transmitted from one or more candidate target cells;
initiate a handover preparation to said selected target cell for said mobile station based on said downlink SINR value; and
hand over said mobile station from said source cell to said selected target cell.

11. A network control node device arranged for communicating in a wireless communication system, said network control node device further being configured to:
monitor a downlink SINR value between said network control node device and a mobile station;
select a target cell for said mobile station based on at least one measurement reports from said mobile station, wherein said measurement reports include measurements on reference signals transmitted from one or more candidate target cells;
initiate a handover preparation to said selected target cell for said mobile station based on said downlink SINR value; and
transmit a handover command message to said mobile station.

12. The network control node device according to claim 11, wherein said network control node device being configured to initiate said handover preparation if said downlink SINR value is less than a SINR threshold value.

13. The network control node device according to claim 11, said network control node device is further configured to estimate said downlink SINR value by using at least one of CQI reports, RSRP reported measurements, and RSRQ reported measurements.

14. The network control node device according to claim 11, said network control node device is further configured to receive said measurement reports; and said network control node device monitor said downlink SINR value when receiving a first measurement report.

15. The network control node device according to claim 11, said network control node device is further configured to monitor an uplink SINR value between said source cell and said mobile station; and said network control node device initiate said handover preparation further based on said uplink SINR value.

16. The network control node device according to claim 11, wherein said selected target cell is a cell which has the strongest signal strength among said candidate target cells in a last measurement report received from said mobile station.

17. The network control node device according to claim 11, wherein said network control node device select said target cell further based on at least one of load in said candidate target cells, cell size of said candidate target cells, transmission power of said candidate target cells and handover history of said candidate target cells.
